(19) United States
(12) Patent Application Publication
(10) Pub. No.: US 2025/0241377 A1
(43) Pub. Date: Jul. 31, 2025

(54) AEROSOL GENERATING DEVICE AND CONTROL METHOD THEREOF

(71) Applicant: KT&G CORPORATION, Daejeon (KR)

(72) Inventors: Yong Hwan KIM, Gyeonggi-do (KR); Young Bum KWON, Gyeonggi-do (KR); Dong Sung KIM, Seoul (KR); Hun ll LIM, Seoul (KR)

(73) Assignee: KT&G CORPORATION, Daejeon (KR)

(21) Appl. No.: 18/567,062

(22) PCT Filed: Sep. 1, 2023
(86) PCT No.: PCT/KR2023/013103

§ 371 Date: Dec. 5, 2023

(30) Foreign Application Priority Data
Sep. 5, 2022 (KR) 10-2022-0112369
Jan. 16, 2023 (KR) 10-2023-0006314

(51) Int. Cl. A24F 40/53; A24F 40/20; A24F 40/465; A24F 40/51; A24F 40/57; G01D 5/20; H05B 6/10

(52) U.S. Cl. CPC A24F 40/53; A24F 40/20; A24F 40/465; A24F 40/51; A24F 40/57; G01D 5/20; H05B 6/108

(57) ABSTRACT

Provided is an aerosol generating device including a heater assembly configured to perform induction heating of a cigarette accommodated in the aerosol generating device by using a susceptor, a cigarette detector including a plurality of inductance detection channels including a plurality of cigarette detection channels configured to detect insertion of the cigarette and an error detection channel configured to detect an external approach of a magnetic body to the aerosol generating device, and a controller configured to determine whether the cigarette is inserted into the aerosol generating device or the magnetic body has externally approached the aerosol generating device, based on a degree of an inductance change detected by the cigarette detection channels relative to an inductance change detected by the error detection channel.

### TECHNICAL FIELD

The disclosure relates to an aerosol generating device and a control method thereof, and more particularly, to an aerosol generating device configured to recognize an input of a cigarette to control the heating of a heater.

### BACKGROUND ART

Recently, the demand for alternative methods to overcome the shortcomings of general cigarettes has been growing. For example, there is growing demand for an aerosol generating device which generates an aerosol by heating an aerosol generating material, rather than by combustion of cigarettes. Accordingly, research on heating-type aerosol generating devices is being actively conducted. To improve the convenience of using an aerosol generating device, there is a need for the aerosol generating device to accurately recognize the insertion of a cigarette and activates heating of a heater.

### DISCLOSURE OF INVENTION

### Technical Problem

There is a need to prevent malfunction of an aerosol generating device due to wrongly recognizing an external object as a cigarette. The technical problems of the disclosure are not limited to the above-described description, and other technical problems may be derived from the embodiments to be described hereinafter.

### Solution to Problem

According to one or more embodiments, an aerosol generating device includes a heater assembly configured to perform induction heating of a cigarette accommodated in the aerosol generating device by using a susceptor, a cigarette detector including a plurality of inductance detection channels including a plurality of cigarette detection channels configured to detect insertion of the cigarette and an error detection channel configured to detect an external approach of a magnetic body to the aerosol generating device, and a controller configured to determine whether the cigarette is inserted into the aerosol generating device or the magnetic body has externally approached the aerosol generating device, based on a degree of an inductance change detected by the cigarette detection channels relative to an inductance change detected by the error detection channel.

According to one or more embodiments, an aerosol generating device includes a heater assembly configured to heat a cigarette accommodated in the aerosol generating device, a shielding material arranged outside the heater assembly and configured to block a variable magnetic field, a cigarette detector including a plurality of inductance detection channels including a plurality of cigarette detection channels configured to detect insertion of the cigarette and an error detection channel configured to detect an external approach of a magnetic body to the aerosol generating device, and a controller configured to determine whether the cigarette is inserted into the aerosol generating device or the magnetic body has externally approached the aerosol generating device, based on a degree of an inductance change detected by the cigarette detection channels relative to an inductance change detected by the error detection channel.

According to one or more embodiments, a control method of an aerosol generating device includes detecting an inductance change, by a cigarette detector including a plurality of inductance detection channels including a plurality of cigarette detection channels configured to detect insertion of a cigarette and an error detection channel configured to detect an external approach of a magnetic body to an aerosol generating device, and determining whether the cigarette is inserted into the aerosol generating device or the magnetic body has externally approached the aerosol generating device, based on a degree of an inductance change detected by the cigarette detection channels relative to an inductance change detected by the error detection channel.

### Advantageous Effects of Invention

According to the above description, by using a correlation among the inductance changes measured in a plurality of inductance detection channels, whether a cigarette is inserted or an external magnetic body has approached may be accurately determined, and a heating operation may be performed only when the cigarette is inserted. As such, a heater when an external object other than the cigarette approaches, thereby preventing malfunction of an aerosol generating device.

### BRIEF DESCRIPTION OF DRAWINGS

FIG. 1 is a view of an aerosol generating system according to an embodiment;

FIG. 2 is a view of an aerosol generating article according to an embodiment;

FIG. 3 is a block diagram illustrating a hardware configuration of an aerosol generating device according to an embodiment;

FIG. 4 is a view for explaining an arrangement of a cigarette detector according to an embodiment;

FIG. 5 is a view for explaining inductance detection channels of a cigarette detector according to an embodiment;

FIG. 6 is a view for explaining areas in which inductance detection channels of a cigarette detector detect inductance change, according to an embodiment;

FIG. 7 is a view for explaining detection of insertion of a cigarette by a cigarette detector, according to an embodiment;

FIG. 8 is a view for explaining an inductance change of inductance detection channels when a cigarette is inserted, according to an embodiment;

FIG. 9 is a view for explaining the detection of a magnetic body outside an aerosol generating device by a cigarette detector, according to an embodiment.

FIG. 10 is a view for explaining an inductance change of inductance detection channels when a magnetic body outside an aerosol generating device approaches, according to an embodiment;

FIG. 11 is a view for describing a cigarette detector included in an aerosol generating device according to another embodiment; and

FIG. 12 is a flowchart of a control method of an aerosol generating device according to an embodiment.

### BEST MODE FOR CARRYING OUT THE INVENTION

According to one or more embodiments, an aerosol generating device includes a heater assembly configured to perform induction heating of a cigarette accommodated in the aerosol generating device by using a susceptor, a cigarette detector including a plurality of inductance detection channels including a plurality of cigarette detection channels configured to detect insertion of the cigarette and an error detection channel configured to detect an external approach of a magnetic body to the aerosol generating device, and a controller configured to determine whether the cigarette is inserted into the aerosol generating device or the magnetic body has externally approached the aerosol generating device, based on a degree of an inductance change detected by the cigarette detection channels relative to an inductance change detected by the error detection channel.

### MODE FOR THE INVENTION

With respect to the terms used to describe in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments should be defined based on the meanings of the terms and the descriptions provided herein.

In addition, unless explicitly described to the contrary, the word “comprise” and changes such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, the embodiments will now be described more fully with reference to the accompanying drawings, in which exemplary embodiments are shown such that one of ordinary skill in the art may easily work the embodiments. The embodiments can, however, be embodied in many different forms and should not be construed as being limited to the embodiments set forth herein.

Hereinafter, embodiments will be described in detail with reference to the drawings.

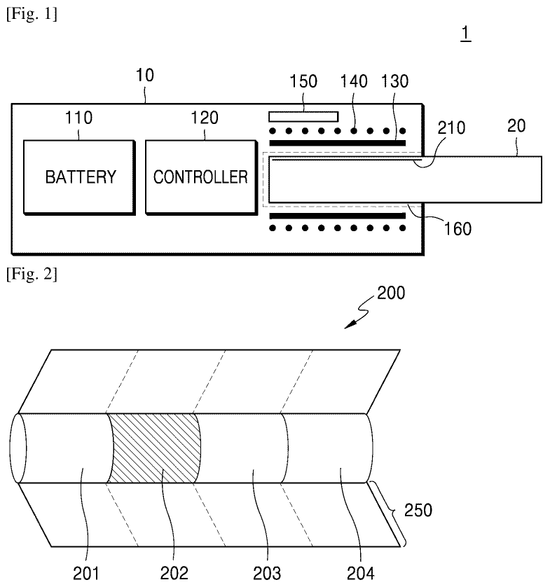

FIG. 1 is a view of an aerosol generating system according to an embodiment.

Referring to FIG. 1, an aerosol generating system 1 may include an aerosol generating device 10 and a cigarette 20. The aerosol generating device 10 may include a cavity 160, which is a cigarette insertion space (a cigarette accommodating space) in which the cigarette 20 is inserted, and may generate aerosol by heating the cigarette 20 inserted into the cavity 160. The cigarette 20, which is a kind of an aerosol generating substrate, may include an aerosol generating material.

The aerosol generating device 10 may include a battery 110, a controller 120, a susceptor 130, an induction coil 140, and a cigarette detector 150. However, an internal structure and arrangement of the aerosol generating device 10 is not limited to the structure illustrated in FIG. 1. Those skilled in the art related to the present embodiment may be understand that some of the hardware components illustrated in FIG. 1 may be omitted or a new configuration may be further added thereto and each hardware component may be variously arranged according to the design of the aerosol generating device 10.

The battery 110 may supply power used to operate the aerosol generating device 10. For example, the battery 110 may supply power such that the induction coil 140 generates a variable magnetic field. In addition, the battery 110 may supply power for operations of other hardware components provided inside the aerosol generating device 10, e.g., operations of the controller 120, various sensors, a user interface, a memory, and the like. The battery 110 may be a rechargeable battery or a disposable battery. For example, the battery 110 may include a lithium polymer (LiPoly) battery but the type of the battery is not limited thereto.

The controller 120 controls the overall operation of the aerosol generating device 10. For example, the controller 120 controls operation of the battery 110, the susceptor 130, the induction coil 140, and the cigarette detector 150 as well as other components included in the aerosol generating device 10. In addition, the controller 120 may also determine whether or not the aerosol generating device 10 is in an operable state by checking states of the respective components of the aerosol generating device 10.

The controller 120 may include at least one processor. A processor may be implemented as an array of a plurality of logic gates or may be implemented as a combination of a general-purpose microprocessor and a memory in which a program executable in the microprocessor is stored. In addition, those skilled in the art to which the present embodiment belongs may appreciate that the processor may include other types of hardware.

The susceptor 130 may include a material that is heated as a variable magnetic field induced by the induction coil 140 is applied to the susceptor 130. For example, the susceptor 130 may include metal or carbon. The susceptor 130 may include at least one of ferrite, ferromagnetic alloy, stainless steel, and aluminum (Al). Also, the susceptor 130 may include at least one of ceramic such as graphite, molybdenum, silicon carbide, niobium, a nickel alloy, a metal film, or zirconia, transition metal such as nickel (Ni) or cobalt (Co), and metalloid such as boron (B) or phosphorus (P). However, it is not limited thereto.

The susceptor 130 may be a tubular shape or a cylindrical shape, and may surround the cavity 160 into which the cigarette 20 is inserted. Therefore, when the cigarette 20 is inserted into the cavity 160 of the aerosol generating device 10, the susceptor 130 may be arranged outside the cigarette 20 to surround the cigarette 20. Accordingly, the temperature of the aerosol generating material in the cigarette 20 may be increased by heat transferred from the susceptor 130.

The induction coil 140 may generate a variable magnetic field when receiving power from the battery 110. The variable magnetic field generated by the induction coil 140 may be applied to the susceptor 130, and thus, the susceptor 130 may be heated. Power supplied to the induction coil 140 may be adjusted under the control of the controller 120, and the temperature at which the susceptor 130 is heated may be properly maintained.

The cigarette detector 150 may detect whether the cigarette 20 is inserted into the cavity 160. The cigarette detector 150 may detect the inductance change amount generated by the insertion and extraction of the cigarette 20. To this end, the cigarette 20 may include an electromagnetic inductor 210. The electromagnetic inductor 210 may change the inductance detected by the cigarette detector 150. The electromagnetic inductor 210 may include a conductor to which an eddy current may be induced and a magnetic body that induces magnetic flux change. For example, the electromagnetic inductor 210 may include a metal material, a magnetic ink, a magnetic tape, and the like. In addition, the electromagnetic inductor 210 may be a metal material such as aluminum. However, embodiments are not limited thereto, and the electromagnetic inductor 210 may include materials, without limitations, that may cause changes in inductance detected by the cigarette detector 150.

The cigarette detector 150 may convert the frequency value that varies according to the change of inductance generated inside or outside the aerosol generating device 10 to an inductance output value and output the inductance output value. Here, the change of inductance generated from the inside or outside of the aerosol generating device 10 may be caused by the insertion or extraction of the cigarette to or from the aerosol generating device 10 or the approach of a magnetic body from the outside of the aerosol generating device 10.

The cigarette detector 150 may include one or more detection coils, and each detection coil may correspond to an inductance detection channel. In other words, the cigarette detector 150 may include one or more inductance detection channels, and each inductance detection channel may detect changes in inductance generated inside or outside the aerosol generating device 10.

The controller 120 may calculate the inductance change amount based on the inductance output value output by the cigarette detector 150, and may determine whether the cigarette 20 is inserted or extracted or a magnetic body is approaching from the outside of the aerosol generating device 10, based on the inductance change amount.

When detecting the insertion of the cigarette 20, the controller 120 may automatically perform a heating operation without an additional external input. For example, when detecting that the cigarette 20 is inserted by using the cigarette detector 150, the controller 120 may control the battery 110 to supply power to the induction coil 140. As a variable magnetic field is generated by the induction coil 140, the susceptor 130 may be heated. Thus, the cigarette 20 placed inside the susceptor 130 may be heated and aerosol may be generated.

In contrast, when the control unit 120 detects the approach of the external magnetic body instead of the insertion of the cigarette 20, heating may not start.

In addition, the aerosol generating device 10 may further include other general-purpose components in addition to the battery 110, the controller 120, the susceptor 130, the induction coil 140, and the cigarette detector 150. For example, the aerosol generating device 10 may further include other sensors (for example, a temperature sensor, a puff sensor, and so on), a user interface, etc. in addition to the cigarette detector 150.

Although not shown in FIG. 1, the user interface may provide information about the state of the aerosol generating device 10 to the user. The user interface may include a display or lamp that outputs visual information, a motor that outputs tactile information, a speaker that outputs sound information, and input/output (I/O) interfacing units (for example, buttons or a touch screen) that receive information input from a user or outputs information to the user. In addition, the user interface may include various interfacing units such as terminals for data communication or receiving charging power, and a communication interfacing module for wireless communication (for example, WI-FI, WI-FI Direct, Bluetooth, Bluetooth low energy (BLE), near-field communication (NFC), or so on) with an external device.

However, the aerosol generating device 10 may selectively include only some of the various user interface examples illustrated above. In addition, the aerosol generating device 10 may include a combination of at least some of the various user interface examples illustrated above. For example, the aerosol generating device 10 may include a touch screen display capable of receiving user input while outputting visual information on a front side thereof. The touch screen display may include a fingerprint sensor, and user authentication may be performed by the fingerprint sensor.

Although not illustrated in FIG. 1, the aerosol generating device 10 and an additional cradle may form together a system. For example, the cradle of the aerosol generating device 10 may be used to charge the battery 110. Alternatively, the induction coil 140 may be heated in a state in which the cradle and the aerosol generating device 10 are coupled to each other.

FIG. 2 is a view of an aerosol generating article according to an example embodiment.

Referring to FIG. 2, the aerosol generating article 200 may correspond to the cigarette 20 of FIG. 1. The aerosol generating article 200 may be divided into a first portion 201, a second portion 202, a third portion 203, and a fourth portion 204, and the first portion 201, the second portion 202, the third portion 203, and the fourth portion 204 may include an aerosol generating element, a tobacco element, a cooling element, and a filter element, respectively. In detail, the first portion 201 may include an aerosol generating material, the second portion 202 may include a tobacco material and a moisturizer, the third portion 203 may include a means for cooling an airflow passing through the first portion 201 and the second portion 202, and the fourth portion 204 may include a filter material.

The first portion 201, the second portion 202, the third portion 203, and the fourth portion 204 may be sequentially arranged in a length direction of the aerosol generating article 200. Here, the longitudinal direction of the aerosol generating article 200 may be a direction in which a length of the aerosol generating article 200 extends. For example, the length direction of the aerosol generating article 200 may be a direction from the first portion 201 to the fourth portion 204. Accordingly, aerosols generated in at least one of the first portion 201 and the second portion 202 may sequentially pass through the first portion 201, the second portion 202, the third portion 203, and the fourth portion 204 to form an airflow, and thus, a smoker may inhale the aerosol from the fourth portion 204.

The first portion 201 may include an aerosol generating element. The first portion 201, which is an aerosol generating element, may contain other additives such as flavors, wetting agents, and/or organic acid, and may include a flavoring liquid such as menthol or a moisturizer. Here, the aerosol generating element may include at least one of glycerin, propylene glycol, ethylene glycol, dipropylene glycol, diethylene glycol, triethylene glycol, tetraethylene glycol, and oleyl alcohol.

The first portion 201 may include a wound sheet, and the aerosol generating element may be included in the first portion 201 by being impregnated in the wound sheet. In addition, other additives such as flavors, a wetting agent, and/or organic acid may be included in the first portion 201 in a state of being absorbed into the crimped sheet. The crimped sheet may be a sheet including a polymer material. For example, the polymer material may include at least one of paper, cellulose acetate, lyocell, and polylactic acid. For example, the wound sheet may be a paper sheet from which a smell is not generated due to heat even when the paper is heated to a high temperature. However, it is not limited thereto.

The first portion 201 may extend from an end of the aerosol generating article 200 to a point of about 7 mm to about 20 mm, and the second portion 202 may extend from a point where the first portion 201 ends to a point of about 7 mm to about 20 mm. However, the present disclosure is not limited to this numerical range, and a length to which each of the first portion 210 and the second portion 202 extends may be appropriately adjusted within a range that may be easily changed by one of ordinary skill in the art.

The second portion 202 may include a tobacco element. The tobacco element may include a certain type of tobacco material. For example, the tobacco element may include a type of pipe tobacco, a type of tobacco particle, a type of tobacco sheet, a type of tobacco beads, a type of tobacco granule, a type of tobacco powder, or a type of tobacco extract. In addition, the tobacco material may include, for example, one or more of tobacco leaves, tobacco vein, expanded tobacco, cut tiny bits, tobacco sheet tiny bits, and reconstituent tobacco.

The third portion 203 may cool an airflow passing through the first portion 201 and the second portion 202. The third portion 203 may be made of a polymer material or a biodegradable polymer material, and may have a cooling function. For example, the third portion 203 may be made of a polyactic acid (PLA) fiber, but is not limited thereto. Alternatively, the third portion 203 may be made of a cellulose acetate filter having a plurality of holes. However, the third portion 203 is not limited to the above-described example, and a material that performs a function of cooling aerosols may be used without limitation. For example, the third portion 203 may be a tube filter or a branch pipe filter including a hollow therein.

The fourth portion 240 may include a filter material. For example, the fourth portion 240 may be a cellulose acetate filter. The shape of the fourth portion 204 is not limited. For example, the fourth portion 204 may be a cylinder-type rod or a tube-type rod including a hollow therein. In addition, the fourth portion 204 may be a recess-type rod. When the fourth portion 204 includes a plurality of segments, at least one of the plurality of segments may have a different shape.

The fourth portion 204 may be formed to generate flavors. For example, a flavoring liquid may be sprayed onto the fourth portion 204, or an additional fiber to which a flavoring liquid is applied may be inserted into the fourth portion 204.

The aerosol generating article 200 may include a wrapper 250 surrounding at least a portion of the first portion 201 to the fourth portion 204. In addition, the aerosol generating article 200 may include the wrapper 250 surrounding all of the first portion 201 to the fourth portion 204. The wrapper 250 may be positioned on the outermost side of the aerosol generating article 200, and the wrapper 250 may be a single wrapper, but may be a combination of a plurality of wrappers.

The wrapper 250, which is an electromagnetic inductor 210 for cigarette detection using the cigarette detector 150 of FIG. 1, may include a heat conductive material. For example, the heat conductive materials may be a metal foil such as a silver (Ag) foil paper, an aluminum (Al) foil paper, a copper (Cu) foil paper, etc., but are not limited thereto. The heat conductive material included in the wrapper 250 may evenly distribute heat transmitted to the first portion and the second portion 202 to improve heat conductivity, thereby improving the taste of tobacco. In addition, the heat conductive material included in the wrapper 250 may function as a susceptor.

The heat conductive material of the wrapper 250 may change the inductance of the cigarette detector 150. Based on the inductance change detected in the cigarette detector 150, the aerosol generating device 10 (FIG. 1) may determine whether the aerosol generating article 200 is inserted into or extracted from the aerosol generating device 10 (FIG. 1).

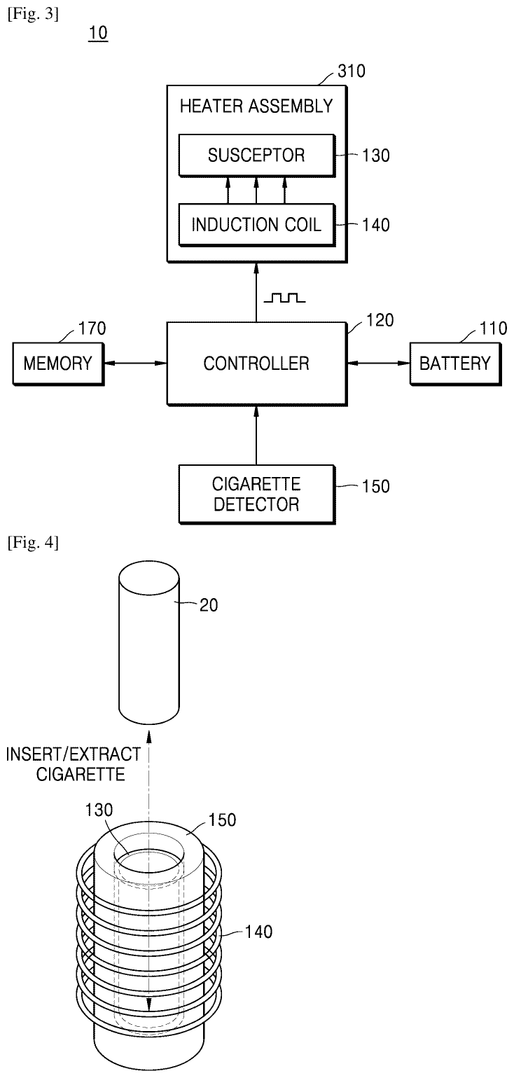

FIG. 3 is a block diagram illustrating a hardware configuration of an aerosol generating device according to an embodiment.

Referring to FIG. 3, the aerosol generating device 10 may include the battery 110, the controller 120, the susceptor 130, the induction coil 140, and the cigarette detector 150, and a memory 170. FIG. 3 illustrates the aerosol generating device 10 including components relating to the present embodiment. Therefore, it will be understood by one of ordinary skill in the art related to the present embodiment that other general-purpose components may be further included in the aerosol generating device 10, in addition to the components illustrated in FIG. 3. The operations of the aerosol generating device 10 described in FIG. 1 may be applied to the aerosol generating device 10 of FIG. 3.

The cigarette detector 150 detects whether the cigarette 20 is inserted into or extracted from the cavity 160 (FIG. 1) or the magnetic body has approached the outside of the aerosol generating device 10.

In detail, the cigarette detector 150 may be implemented as an inductive sensor that can detect the change of inductance therearound. As the cigarette 20 is inserted or extracted, the inductance change amount that changes according to the distance between the electromagnetic inductor 210 provided in the cigarette 20 and the inductive sensor may be measured by the cigarette detector 150. In addition, the cigarette detector 150 may measure the inductance change amount that changes as the magnetic body approaches the outside of the aerosol generating device 10. Accordingly, the cigarette detector 150 may transmit data about inductance change amount caused by the insertion/extraction of the cigarette 20 or the approach of an external magnetic body to the controller 120.

The controller 120 may determine whether the cigarette 20 is inserted/extracted or an external magnetic body is approaching based on the inductance change amount data obtained from the cigarette detector 150.

In detail, the cigarette detector 150 may include a plurality of inductance detection channels including a plurality of cigarette detection channels configured to detect the insertion of the cigarette 20 and an error detection channel that detects the approach of a magnetic body outside the aerosol generating device 10. That is, the cigarette detector 150 may include a plurality of inductive sensors that may each independently detect the inductance change amount. Each inductive sensor corresponds to each inductance detection channel of the cigarette detector 150.

When the cigarette detector 150 does not include an inductance detection channel such as the error detection channel configured to detect the approach of an external magnetic body, the cigarette detector 150 may wrongly detect an inductance change caused by the external magnetic body as an inductance change caused by the insertion of the cigarette 20. Accordingly, a heater assembly 310 may start heating even when there is no inserted cigarette 20, thereby causing malfunctions of the aerosol generating device 10. In this regard, the cigarette detector 150 of the disclosure may include independent inductance detection channels such as the cigarette detection channel and the error detection channel to prevent erroneous heating.

For the inductance detection channels to immediately detect the inductance change amount, power is continuously supplied to the inductance detection channels even in a standby mode where aerosols are not generated by the aerosol generating device 10. When the inductance change is detected by the cigarette detector 150, the controller 120 determines whether the cigarette 20 is inserted into the aerosol generating device 10 or the magnetic body outside the aerosol generating device 10 has approached based on a degree of inductance change detected by the cigarette detection channels relative to the inductance change detected by the error detection channel.

In detail, the controller 120 perform the determining based on a difference between the inductance change amount detected by each of the cigarette detection channels and the inductance change amount detected by the error detection channel. For example, the controller 120 may perform the determining by comparing a sum of a first difference and a second difference with a predetermined threshold value, the first difference being a difference between a change amount detected by a first cigarette detection channel and a change amount detected by the error detection channel, and the second difference being a difference between a change amount detected by a second cigarette detection channel and a change amount detected by the error detection channel. As a result, the controller 120 determines that the cigarette 20 is inserted into the aerosol generating device 10 when the sum of the first difference and the second difference is equal to or greater than the predetermined threshold value. However, if the sum of the first difference and the second difference is less than the predetermined threshold value, the controller 120 determines that the magnetic body has approached the outside of the aerosol generating device 10, rather than the cigarette 20 being inserted.

When the controller 120 determines that the cigarette 20 is inserted into the aerosol generating device 10, the controller 120 may control the heater assembly 310 to start induction heating of the cigarette 20. However, when it is determined that the magnetic body has approached the outside of the aerosol generating device 10, rather than the cigarette 20 being inserted, the induction heating is prevented from being started. When the controller 120 determines that the cigarette 20 is extracted, heating may be terminated by blocking the power supplied to the heater assembly 310.

The heater assembly 310 includes the susceptor 130 and the induction coil 140 and generates aerosols by using the susceptor 130 arranged to perform induction heating of the cigarette 20 accommodated in the aerosol generating device 10. In this case, the controller 120 may control the power supplied to the heater assembly 310 through a pulse width modulation (PWM) method. For example, the controller 120 may include an additional integrated circuit (IC) to control only the power supply to the induction coil 140.

The memory 170 may store various data processed by the aerosol generating device 10, data processed by the controller 120, and data to be processed by the controller 120. The memory may be implemented as various types, such as random access memory (RAM) such as dynamic random access memory (DRAM) and static random access memory (SRAM), read-only memory (ROM), and electrically erasable programmable read-only memory (EEPROM).

The memory 170 may store a reference value (or threshold values) of the inductance change amount to determine the insertion/extraction of the cigarette 20 or the approach of an external magnetic body. In another embodiment, the memory 170 may store operation time of the aerosol generating device 10, the greatest number of puffs, the current number of puffs, at least one temperature profile, various data on a user's smoking pattern, and so on.

FIG. 4 is a view for explaining the arrangement of the cigarette detector according to an embodiment.

Referring to FIG. 4, the susceptor 130 is cylindrical, and the cavity (see 160 in FIG. 1) for receiving the cigarette 20 is formed inside the susceptor 130. That is, the susceptor 130 is arranged to perform induction heating of the cigarette 20 accommodated in the aerosol generating device 10.

The induction coil 140 may be arranged outside the susceptor 130 along the length direction of the susceptor 130. Power may be supplied to the induction coil 140 by the control of the controller 120 (FIG. 3) to generate a variable magnetic field to thereby control the induction heating of the susceptor 130.

A cigarette detector 150 is arranged in an area between the susceptor 130 and the induction coil 140. The length of the cigarette detector 150 is longer than the length of the susceptor 130, and the susceptor 130 may be arranged to be included within the length of the cigarette detector 150, but embodiments are not limited thereto. Because the magnetic field is not generated by the induction coil 140 before the induction coil 140 starts the induction heating operation, it can be determined that the inductance change detected by the cigarette detector 150 is caused by the insertion of the cigarette 20 or the approach of the external magnetic body.

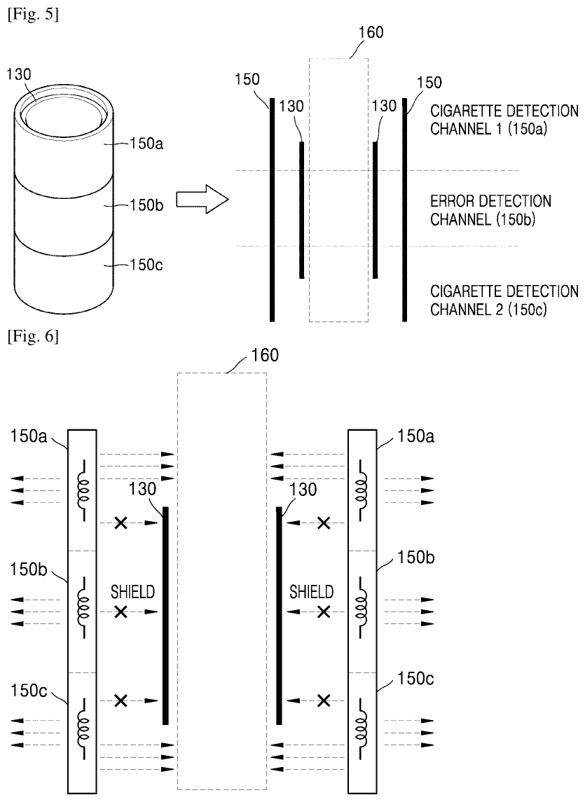

FIG. 5 is a view for explaining the inductance detection channels of the cigarette detector according to an embodiment.

Referring to FIG. 5, the cigarette detector 150 may include a plurality of inductance detection channels such as the first cigarette detection channel 150a, the error detection channel 150b, and the second cigarette detection channel 150c. As shown in FIG. 5, the plurality of inductance detection channels may be arranged in a row outside the susceptor 130 along the length direction of the susceptor 130.

Among the plurality of inductance detection channels, each of the cigarette detection channels 150a and 150c may be arranged to extend further than the susceptor 130 in the length direction. The error detection channel 150b may be arranged between the cigarette detection channels 150a and 150c, and may be shorter than a length of the susceptor 130.

The susceptor 130 surrounds the outer circumferential surface of the cavity 160. which is a cigarette insertion space (a cigarette accommodation space) into which the cigarette is inserted. Also, each of the first cigarette detection channel 150a, the error detection channel 150b, and the second cigarette detection channel 150c of the cigarette detector surrounds the outer circumferential surface of the susceptor 130.

FIG. 6 is a view for explaining areas in which the inductance detection channels of the cigarette detector detect inductance change, according to an embodiment.

Referring to FIG. 6, the first cigarette detection channel 150a and the second cigarette detection channel 150c may detect the inductance change in the cavity 160 inside the susceptor 130 and the inductance change outside the aerosol generating device 10. That is, the inductance change in both the inside and outside of the cigarette detector 150 may be detected. Therefore, the first cigarette detection channel 150a and the second cigarette detection channel 150c may detect the inductance change when the cigarette 20 is inserted into or extracted from the cavity 160 or when an external magnetic body approaches the aerosol generating device.

According to the channel arrangement of FIG. 6, some areas of the first cigarette detection channel 150a and the second cigarette detection channel 150c may not detect the inductance change in some areas (some directions) in the cavity 160 due to the shielding of the susceptor 130. However, embodiments are not limited to the arrangement shown in FIG. 6, and the first cigarette detection channel 150a and the second cigarette detection channel 150c may be arranged in locations totally deviated from the length of the susceptor 130 to avoid shielding of the susceptor 130.

The error detection channel 150b may only detect the inductance change outside the aerosol generating device 10, and may not detect the inductance change of the cavity 160 inside the susceptor 130. That is, the detection of the inductance change inside (the cavity 160) the susceptor 130 by the error detection channel 150b may be blocked by the shielding of the susceptor 130, and may detect only the inductance change caused by the approach of an external magnetic body outside the susceptor 130.

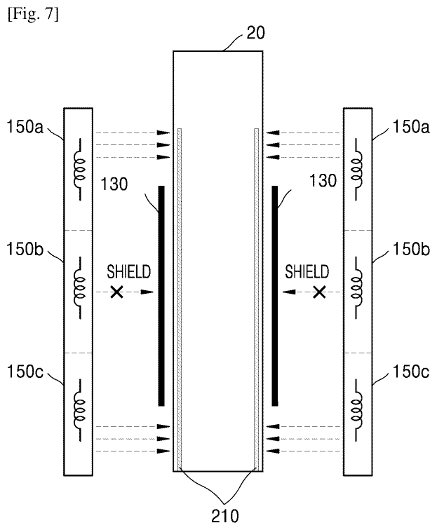

FIG. 7 is a view for explaining the detection of insertion of a cigarette by the cigarette detector, according to an embodiment.

Referring to FIG. 7, when the cigarette 20 is inserted, each of the first cigarette detection channel 150a and the second cigarette detection channel 150c may detect the inductance change caused by the electromagnetic inductor 210 of a metal material included in the inserted cigarette 20. That is, unlike the embodiment of FIG. 6 where the cigarette 20 is not inserted into the cavity 160, the inductance measurement values of the first cigarette detection channel 150a and the second cigarette detection channel 150c may change in FIG. 7 as the cigarette 20 is inserted. Here, the change amount of the inductance measurement value may correspond to the change amount of a sensing frequency of the inductive sensor provided in each of the first cigarette detection channel 150a and the second cigarette detection channel 150c.

In contrast, because the error detection channel 150b may not detect the inductance change inside the susceptor 130 due to the shielding of the susceptor 130, even if the cigarette 20 is inserted, there is almost no change in the inductance measurement value of the error detection channel 150b.

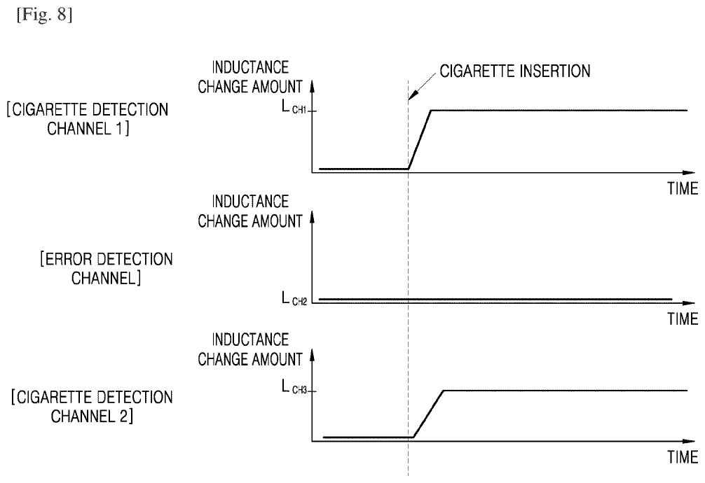

FIG. 8 is a view for explaining an inductance change of inductance detection channels when a cigarette is inserted, according to an embodiment.

Referring to FIG. 8, graphs of inductance change amounts of the first cigarette detection channel 150a, the error detection channel 150b, and the second cigarette detection channel 150c when the cigarette 20 described in FIG. 7 is inserted are illustrated.

First, graphs of the inductance change amounts of the first cigarette detection channel 150a and the second cigarette detection channel 150c will be described. When the cigarette 20 is inserted, the inductance measurement value of each of the first cigarette detection channel 150a and the second cigarette detection channel 150c may change rapidly. In other words, the inductance change amount is rapidly increased by the electromagnetic inductor 210 in the cigarette 20 according to the insertion of the cigarette 20.

However, due to the shielding of the susceptor 130, the inductance measurement value of the error detection channel 150b is barely changed even when the cigarette 20 is inserted.

As described in FIG. 3, the controller 120 may determine whether the cigarette 20 is inserted based on the phenomenon of inductance change.

Table 1 below shows simulation results of repeatedly measuring the inductance change amount in each of the first cigarette detection channel 150a, the error detection channel 150b, and the second cigarette detection channel 150c when the cigarette 20 is inserted.

TABLE 1
Inductance change amount of each channel
when cigarette is inserted

| | L_{CH1} | L_{CH2} | L_{CH3} | diff |
|---|---|---|---|---|
| | 73 | 7 | 76 | 135 |
| | 110 | 7 | 81 | 177 |
| | 34 | 3 | 41 | 69 |
| | 111 | 8 | 44 | 139 |
| | 43 | 3 | 45 | 82 |
| | 101 | 8 | 54 | 139 |
| | 107 | 8 | 96 | 187 |
| | 104 | 7 | 31 | 121 |
| | 54 | 4 | 37 | 83 |
| | 111 | 8 | 96 | 191 |
| | 111 | 9 | 76 | 169 |
| | 108 | 8 | 68 | 160 |
| | 53 | 3 | 42 | 89 |
| | 32 | 3 | 47 | 73 |
| | 107 | 8 | 93 | 184 |
| | 107 | 9 | 86 | 175 |
| | 33 | 4 | 41 | 66 |
| | 34 | 4 | 39 | 65 |
| | 34 | 4 | 46 | 72 |
| | 107 | 8 | 76 | 167 |
| | 34 | 3 | 45 | 73 |
| | 113 | 8 | 53 | 150 |
| | 112 | 8 | 89 | 185 |
| | 105 | 8 | 91 | 180 |
| Max | 113 | 9 | 96 | 191 |
| Min | 32 | 3 | 31 | 65 |
| Average | 81 | 6 | 62 | 130 |

“L_{CH1}” is an inductance change amount detected in the first cigarette detection channel 150a, “L_{CH2}” is an inductance change amount detected in the error detection channel 150b, and “L_{CH3}” is an inductance change amount detected in the second cigarette detection channel 150c. “diff” corresponds to the value of (L_{CH1}-L_{CH2})+ (L_{CH3}-L_{CH2}).

Referring to Table 1, when the cigarette 20 is inserted, it can be seen that the inductance change amounts (L_{CH1} and L_{CH3}) of the first cigarette detection channel 150a and the second cigarette detection channel 150c are much greater than inductance change amount (L_{CH2}) detected in the error detection channel 150b. This is because the first cigarette detection channel 150a and the second cigarette detection channel 150c may detect the inductance change by the electromagnetic inductor 210 in the cigarette 20, but the error detection channel 150b cannot detect the inductance change inside the susceptor 20.

The controller 120 may determine whether the cigarette 20 is inserted by considering the differences in the detection characteristics of the inductance detection channels.

In detail, determination may be performed based on a degree of difference between the inductance change amounts (L_{CH1} and L_{CH3}) detected by the cigarette detection channels 150a and 150c and the inductance change amount (L_{CH2}) detected by the error detection channel 150b. For example, the controller 120 may perform determination by comparing the “diff” value ((L_{CH1}-L_{CH2})+ (L_{CH3}-L_{CH2})), which is a sum of the a first difference (L_{CH1}-L_{CH2}) between the change amount (L_{CH1}) detected by the first cigarette detection channel 150a and the change amount (L_{CH2}) detected by the error detection channel 150b and a second difference (L_{CH3}-L_{CH2}) between the change amount (L_{CH3}) detected by the second cigarette detection channel 150c and the change amount (L_{CH2}) detected by the error detection channel 150b, and a predetermined threshold value. In the present embodiment, for convenience of description, the value of the sum of the first difference and the second difference may be referred to as a “diff” value.

The controller 120 determines that the cigarette 20 is inserted into the aerosol generating device 10 only when the “diff” value is greater than or equal to a predetermined threshold value. That is, if the “diff” value is less than a predetermined threshold value, the controller 120 determines that the cigarette 20 is not inserted. In this case, an external magnetic body may have approached, or a foreign substance excluding the cigarette 20 may have been inserted into the cavity 160.

The threshold value (or reference value) to be compared with the “diff” value may be set in advance. The range of the inductance change amount detected in the inductance detection channel may change according to various factors such as physical characteristics such as the material or thickness of the electromagnetic inductor 210 and sensor characteristics such as the sensitivity of the inductive sensor included in the cigarette 20. In other words, the optimal threshold value may vary according to the characteristics of the components used in the aerosol generating system 1 (see FIG. 1). Therefore, the threshold value may be determined as the optimal value by depending on the inductance change amounts measured from dozens, hundreds, thousands, or millions of times of simulation results using the aerosol generating system 1 (see FIG. 1) to be implemented. For example, the threshold value may be determined in advance based on the statistics such as the minimum and average value of the “diff” values, etc. obtained from the plurality of simulation results.

When the controller 120 determines that the cigarette 20 is inserted into the aerosol generating device 10, the controller 120 may control the heater assembly 310 to start induction heating of the cigarette 20. However, when it is determined that the magnetic body has approached the outside of the aerosol generating device 10, rather than the cigarette 20 being inserted, the heater assembly 310 is controlled to prevent the induction heating from starting.

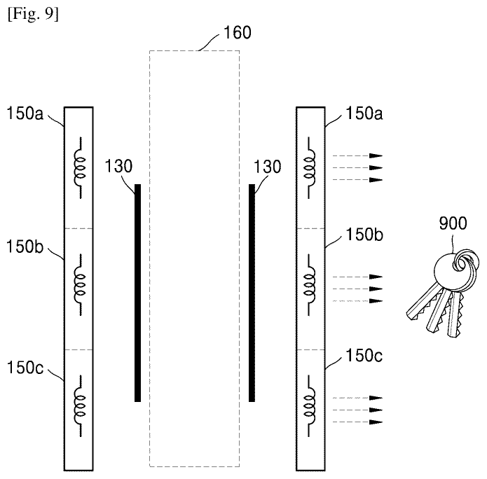

FIG. 9 is a view for explaining the detection of a magnetic body outside the aerosol generating device by the cigarette detector, according to an embodiment.

Referring to FIG. 9, if the external magnetic body 900 approaches the aerosol generating device 10, each of the first cigarette detection channel 150a, the error detection channel 150b, and the second cigarette detection channel 150c may detect the inductance change caused by the approach of an external magnetic body 900. That is, unlike the embodiment shown in FIG. 6 in which there is no external magnetic body approaching the aerosol generating device 10, the inductance measurement values of the first cigarette detection channel 150a, the error detection channel 150b, and the second cigarette detection channel 150c may change when the external magnetic body 900 approaches.

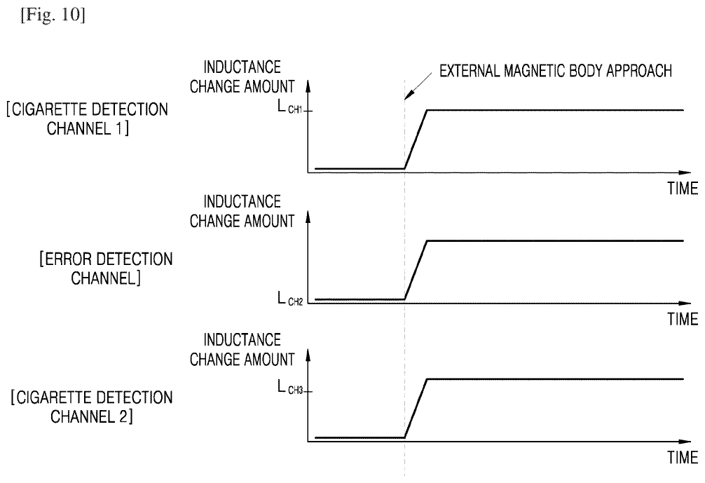

FIG. 10 is a view for explaining the inductance change of the inductance detection channels when the magnetic body outside the aerosol generating device approaches, according to an embodiment.

Referring to FIG. 10, graphs of inductance change amounts of the first cigarette detection channel 150a, the error detection channel 150b, and the second cigarette detection channel 150c when the external magnetic body 900 described in FIG. 9 approaches are illustrated.

From a time point at which the external magnetic body 900 approaches, the inductance measurement value of the first cigarette detection channel 150a, the error detection channel 150b, and the second cigarette detection channel 150c may change rapidly.

Table 2 below shows simulation results of repeatedly measuring the inductance change amount in each of the first cigarette detection channel 150a, the error detection channel 150b, and the second cigarette detection channel 150c when the external magnetic body 900 approaches.

TABLE 2
Inductance change amount of each channel when
external magnetic body has approached

| | L_{CH1} | L_{CH2} | L_{CH3} | diff |
|---|---|---|---|---|
| | 44 | 37 | 64 | 34 |
| | 33 | 29 | 53 | 28 |
| | 19 | 16 | 24 | 11 |
| | 19 | 12 | 13 | 8 |
| | 42 | 35 | 0 | −28 |
| | 32 | 19 | 20 | 14 |
| | 45 | 37 | 55 | 26 |
| | 17 | 9 | 13 | 12 |
| | 42 | 39 | 65 | 29 |
| | 49 | 40 | 60 | 29 |
| | 52 | 29 | 36 | 30 |
| | 30 | 26 | 37 | 15 |
| Max | 52 | 40 | 65 | 34 |
| Min | 17 | 9 | 0 | −28 |
| Average | 35 | 27 | 37 | 17 |

Unlike in Table 1, the approach of the external magnetic body 900 causes rapid inductance change in all inductance detection channels. Accordingly, it can be seen that the “diff” values in Table 2 are mostly less than the “diff” values in Table 1. That is, the “diff” value obtained in a situation in which the external magnetic body 900 has approached is less than the predetermined threshold value. Therefore, if the “diff” value is less than a predetermined threshold value, the controller 120 may determine that the cigarette 20 is not inserted. In this case, it may be determined that an external magnetic body may have approached, or a foreign substance excluding the cigarette 20 may have been inserted into the cavity 160.

In this way, the cigarette detector 150 according to the present embodiment may include an additional inductance detection channel that may detect the insertion of the cigarette 20 and an additional inductance detection channel that may detect the approach of the magnetic body 900 outside the aerosol generating device 10. As such, the cigarette detector 150 may accurately determine whether the cigarette 20 is inserted or the external magnetic body 900 has approached by using the correlation between the inductance change amounts measured in the inductance detection channels. Accordingly, the aerosol generating device 10 according to the present embodiment may perform the heating operation only when the cigarette 20 is actually inserted, and when an external object other than the cigarette has approached, the malfunction of erroneous heating may be prevented.

The controller 120 according to the present embodiment may determine the insertion of the cigarette 20 or the approach of the external magnetic body 900 by using only the calculation of the “diff” value corresponding to the correlation between the inductance change amounts of the inductance channels. Therefore, when compared to other methods in which the insertion of the cigarette 20 or the approach of the external magnetic body 900 is determined by individually comparing the inductance change amount measured in each inductance channel with the individual threshold value step by step, the determination may be more accurate and quicker.

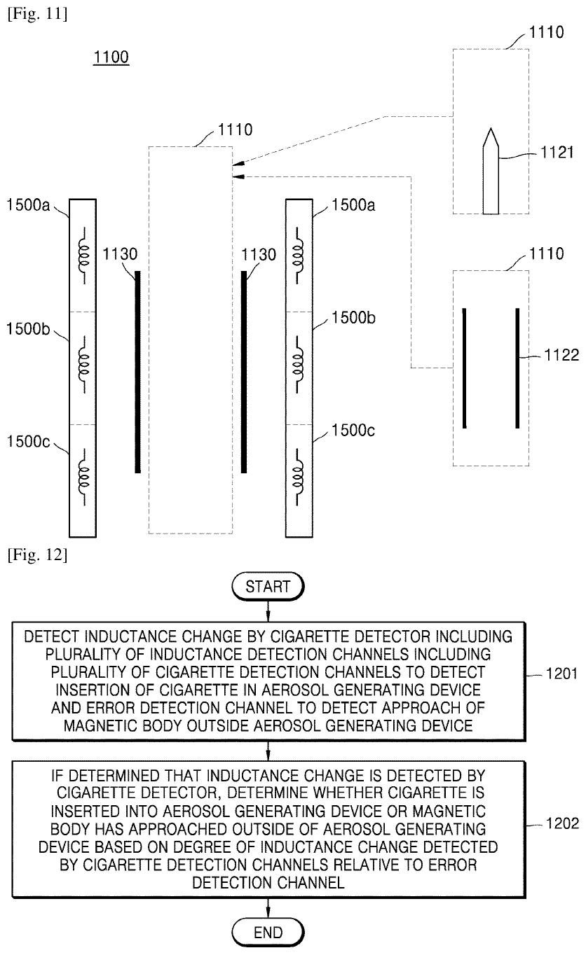

FIG. 11 is a view for describing a cigarette detector included in an aerosol generating device according to another embodiment.

Referring to FIG. 11, unlike the aerosol generating device 10 of FIG. 1, the aerosol generating device 1100 may include, inside a cavity 1110, an internal heating-type elongated heater 1121 to be inserted in the cigarette or an external heating-type cylindrical film heater 1122 that heats the outer side surface of the cigarette. That is, the aerosol generating device 1100 may not include the susceptor 130 of a cylindrical shape and the induction coil 140 described in FIG. 4, and may be implemented with a heater assembly of a different kind.

In the aerosol generating device 1100, a shielding material 1130, instead of the susceptor 130, may be arranged in the location of the susceptor 130 of the aerosol generating device 10 shown in the other drawings. A plurality of inductance detection channels 1500a, 1500b, and 1500c are arranged in a row along the length direction of the aerosol generating device 1100 (i.e., the length direction of the shielding material 1130).

The shielding material 1130 to block the detection of inductance changes due to the insertion of the cigarette is arranged inside the error detection channel 1500b, and thus, the error detection channel 1500b may only detect the approach of an external magnetic body. Each of the cigarette detection channels 1500a and 1500c may be arranged to extend further than the shielding material 1130 in the length direction to detect the inductance change caused by electromagnetic inductors such as metal materials included in the cigarette.

That is, the aerosol generating device 1100 is only different from the aerosol generating device 10 of FIG. 1 in terms of the implementation method of the heater assembly because the shielding material 1130 is arranged instead of the susceptor 130, and other features of the embodiments described in FIGS. 1 to 10 may be applied to the method of determining the insertion of the cigarette or the approach of the external magnetic body by using the inductance detection channels 1500a, 1500b, and 1500c of the cigarette detector. The shielding material may be implemented as a substance that may block a magnetic field generated by the inductive sensor. Because the physical characteristics of the shielding material may be different from those of the susceptor 130, the threshold value to be compared with the “diff” value may be set differently from when the susceptor 130 is used.

FIG. 12 is a flowchart of a control method of the aerosol generating device according to an embodiment. The control method of FIG. 12 corresponds to the temporally ordered processing operations of the aerosol generating device 10 described in the previous drawings. Thus, the descriptions above may be omitted below but may still be applied to the control method of FIG. 12.

In operation 1201, the cigarette detector 150 detects the inductance change. The cigarette detector 150 includes the plurality of inductance detection channels including the plurality of cigarette detection channels to detect the insertion of the cigarette 20 in the aerosol generating device 10 and the error detection channel to detect the approach of the magnetic body outside the aerosol generating device 10.

In operation 1202, when it is determined that the inductance change is detected by the cigarette detector 150, the controller 120 determines whether the cigarette 20 is inserted in the aerosol generating device 10 or the magnetic body has approached the outside of the aerosol generating device 10, based on the degree of inductance change detected by the cigarette detection channels relative to the inductance change detected by the error detection channel.

The above method may be prepared as a program executable on a computer, and may be implemented on a general-purpose digital computer that operates the program by using a computer-readable recording medium. In addition, the structure of data used in the above method may be recorded in a computer-readable recording medium through various methods. The computer-readable recording medium includes magnetic storage media (e.g., ROM, RAM, USB, a floppy disk, a hard disk, etc.) and optical reading media (e.g., CD-ROM, DVD, etc.).

Those of ordinary skill in the art related to the present embodiments may understand that various changes in form and details can be made therein without departing from the scope of the characteristics described above. Therefore, the disclosed methods should be considered in a descriptive point of view, not a restrictive point of view. The scope of the present disclosure is defined by the appended claims rather than by the foregoing description, and all differences within the scope of equivalents thereof should be construed as being included in the disclosure.

1. An aerosol generating device comprising:
a heater assembly configured to perform induction heating of a cigarette accommodated in the aerosol generating device by using a susceptor;
a cigarette detector comprising a plurality of inductance detection channels comprising a plurality of cigarette detection channels configured to detect insertion of the cigarette and an error detection channel configured to detect an external approach of a magnetic body to the aerosol generating device; and
a controller configured to determine whether the cigarette is inserted into the aerosol generating device or the magnetic body has externally approached the aerosol generating device, based on a degree of an inductance change detected by the cigarette detection channels relative to an inductance change detected by the error detection channel.

2. The aerosol generating device of claim 1, wherein the controller is configured to perform the determining based on a degree of difference between an inductance change detected by each of the cigarette detection channels and the inductance change detected by the error detection channel.

3. The aerosol generating device of claim 2, wherein
the plurality of cigarette detection channels include a first cigarette detection channel and a second cigarette detection channel,
the controller is further configured to perform the determining by comparing a sum of a first difference and a second difference with a predetermined threshold value, the first difference being a difference between an inductance change detected by the first cigarette detection channel and the inductance change detected by the error detection channel, and the second difference being a difference between an inductance change detected by the second cigarette detection channel and the inductance change detected by the error detection channel.

4. The aerosol generating device of claim 3, wherein the controller is further configured to:
determine that the cigarette is inserted into the aerosol generating device, when the sum of the first difference and the second difference is equal to or greater than the predetermined threshold value, and determine that the magnetic body has externally approached to the aerosol generating device, when the value of the sum of the first difference and the second difference is less than the predetermined threshold value.

5. The aerosol generating device of claim 1, wherein the plurality of inductance detection channels are arranged in a row outside the susceptor along a length direction of the susceptor.

6. The aerosol generating device of claim 5, wherein the error detection channel is arranged between the cigarette detection channels and is shorter than a length of the susceptor.

7. The aerosol generating device of claim 6, wherein the error detection channel is blocked from detecting an inductance change inside the susceptor by shielding of the susceptor, and detects an inductance change caused by the external approach of the magnetic body.

8. The aerosol generating device of claim 5, wherein
the cigarette detection channels extend further than the susceptor in the length direction, and,
when the cigarette is inserted, each of the cigarette detection channels detects an inductance change caused by an electromagnetic inductor included in the inserted cigarette.

9. The aerosol generating device of claim 1, wherein the controller is further configured to:
control the heater assembly to start the induction heating of the cigarette when it is determined that the cigarette is inserted into the aerosol generating device, and
prevent the induction heating from starting when it is determined that the magnetic body has externally approached the aerosol generating device.

10. An aerosol generating device comprising:
a heater assembly configured to heat a cigarette accommodated in the aerosol generating device;
a shielding material arranged outside the heater assembly and configured to block a variable magnetic field;
a cigarette detector comprising a plurality of inductance detection channels comprising a plurality of cigarette detection channels configured to detect insertion of the cigarette and an error detection channel configured to detect an external approach of a magnetic body to the aerosol generating device; and
a controller configured to determine whether the cigarette is inserted into the aerosol generating device or the magnetic body has externally approached the aerosol generating device, based on a degree of an inductance change detected by the cigarette detection channels relative to an inductance change detected by the error detection channel.

11. The aerosol generating device of claim 10, wherein the controller is further configured to perform the determining based on a degree of difference between an inductance change detected by each of the cigarette detection channels and the inductance change detected by the error detection channel.

12. The aerosol generating device of claim 10, wherein
the plurality of inductance detection channels are arranged in a row along a length direction of the aerosol generating device,
the shielding material is arranged inside the error detection channel, and
each of the cigarette detection channels are arranged to extend further than the shielding material in the length direction to detect an inductance change caused by an electromagnetic inductor included in the cigarette.

13. A control method of an aerosol generating device, the method comprising:
detecting an inductance change, by a cigarette detector comprising a plurality of inductance detection channels comprising a plurality of cigarette detection channels configured to detect insertion of a cigarette and an error detection channel configured to detect an external approach of a magnetic body to an aerosol generating device; and, determining whether the cigarette is inserted into the aerosol generating device or the magnetic body has externally approached the aerosol generating device, based on a degree of an inductance change detected by the cigarette detection channels relative to an inductance change detected by the error detection channel.

14. The method of claim 13, wherein the determining is performed based on a difference between an inductance change detected by each of the cigarette detection channels and the inductance change detected by the error detection channel.

15. The method of claim 13, further comprising controlling the heater assembly to start induction heating of the cigarette when it is determined that the cigarette is inserted into the aerosol generating device, wherein the induction heating is not started when it is determined that the magnetic body has externally approached the aerosol generating device.
